(19) United States
(12) Patent Application Publication
(10) Pub. No.: US 2014/0276286 A1
(43) Pub. Date: Sep. 18, 2014

(54) Non-Woven Garment For Deep Vein Thrombosis Prevention

(71) Applicant: Compression Therapy Concepts, Inc., Eatontown, NJ (US)

(72) Inventors: Orlando Mansur, JR., Eatontown, NJ (US); Leonard Nass, Eatontown, NJ (US)

(21) Appl. No.: 14/216,808

(22) Filed: Mar. 17, 2014

Related U.S. Application Data
(60) Provisional application No. 61/787,303, filed on Mar. 15, 2013.

(51) Int. Cl. A61H 9/00

(52) U.S. Cl. CPC A61H 9/0078
USPC 601/151

(57) ABSTRACT

A non-woven garment for deep vein thrombosis prevention includes a body having a central panel, a left side panel, and a right side panel formed with a number of attachment straps having an integral fastener and a cover. A single air chamber receiving air from a pump through a flexible air supply tube is formed on the central penal when the body and the cover are welded through an RF welding method. The body and the cover are made of the same dielectric material for their inner layers to be welded and another same material for the outer layers which can be placed against a patient's skin. The one-step RF welding method eliminates the need for tricot lining and binding and less material is used in manufacturing. Thus, the present invention significantly reduces the manufacturing steps, time, cost, and use of material in manufacturing.

### RELATED APPLICATION

This application claims the benefit of priority to U.S. Provisional Application No. 61/787,303, filed on Mar. 15, 2013, entitled “Non-Woven Garment For Deep Vein Thrombosis Prevention”, and currently co-pending.

### FIELD OF THE INVENTION

The present invention relates generally to medical and therapy devices. The present invention is more particularly useful as a compression garment for use in the prevention of deep vein thrombosis. The present invention is particularly useful to prevent deep vein thrombosis during periods of low or no activity by continually circulating blood through a patient's extremities.

### BACKGROUND OF THE INVENTION

Deep Vein Thrombosis, or “DVT”, is a blood clot (“thrombus”) that forms in a vein deep in the body. A thrombus occurs when blood thickens and dumps together. Most of these thrombi occur in the lower leg or thigh; however, they can also occur in other parts of the body. Thrombi located in the thigh are more likely to break off and cause a pulmonary embolism (“PE”) than clots in the lower leg or other parts of the body. The clots that form dose to the skin usually cannot break off and cause a PE due to their reduced size and the reduced pressures exerted on them.

A DVT or a portion of it, can break off and travel through the bloodstream where it can enter the lung and block blood flow. This condition is called pulmonary embolism, which is considered to be very serious due to its likelihood of causing damage to the lungs and other organs and quite possibly leading to death. This condition affects more than 2.5 million Americans each year and is associated with an estimated 50,000 to 200,000 deaths annually.

The venous system is designed to allow for the return of blood to the right side of the heart. Veins are not passive tubes through which blood passes, but are a system that uses muscular compressions, gravity, and inter-venous valves to promote and control the flow of blood through them. The valves are located along the entire length of the vein and ensure that blood only flows in one (1) direction, toward the heart. Blood flow may easily pass through the valve in the direction toward the heart, but when pressure is greater above the valve than below, the cusps will come together, thereby closing the valve and stopping the further flow of blood to the heart.

The valves consist of two (2) very thin-walled cusps that originate at opposite sides of the vein wall and come together to meet at the midline of the vein. The diameter of the vein is slightly lamer just behind the valve where the cusps attach to the vein wail. Due to the larger diameter of the vein and the propensity for blood to collect and stagnate between the valve cusps and the vein wall, thrombi formation in this area is more likely.

The most common causes of DVT are venous stasis, blood vessel wall injury, and hypercoagulability. Venous stasis is the reduction of blood flow, most notably in the areas of venous valves, usually caused by extended periods of inactivity. These periods of inactivity minimize the muscular compressions applied to the veins, and remove the forces used to propel the blood through the veins, accordingly. This reduction in flow allows the blood to collect and congeal, thereby forming a clot. The conditions that contribute to venous stasis include heart disease, obesity, dehydration, pregnancy, a debilitated or bed-ridden state, stroke, and surgery. Stasis has been known to develop with surgical procedures lasting as little as thirty (30) minutes.

Vessel wall injury can disrupt the lining of the vein, thereby removing the natural protections against clotting. The loss of natural protection will increase the chances of clot formation and the subsequent mobilization of the clot that can lead to a PE. Some of the major causes of vessel wall injury are trauma from fractures and bums, infection, punctures of the vein, injection of irritant solutions, susceptibility to DVT, and major surgeries.

Hypercoagulability exists when coagulation outpaces fibrinolysis, which is the body's natural mechanism to inhibit clot formation. When this condition exists, the chances of clot formation, especially in areas of low blood flow, are greatly increased. Some causes of hypercoagulability are trauma, surgery, malignancy, and systemic infection. A typical treatment is the administration of an anti-coagulant such as of low-molecular-weight heparin.

It is recognized that clots usually develop first in the calf veins and “grow” in the direction of flow in the vein. The clots usually form behind valve pockets where blood flow is lowest. Once a clot forms, it either enlarges until it is enveloped, which causes the coagulation process to stop, or the clot may develop a “tail” which has a high chance of breaking off and becoming mobile where it can enter the pulmonary system and become lodged in the lungs.

In a patient with DVI, the goals are to minimize the risk of a PE, limit further clots, and facilitate the resolution of existing clots. If a potential clot is suspected or detected, bed rest is usually recommended to allow for the clot to stabilize and adhere to the vein wall, thereby minimizing the chance of the clot becoming mobile such that it can travel to the lungs. A more effective preventative measure is ambulation, which is to walk about or move from place to place. Ambulation requires muscle movement. The muscle movement will provide a continuous series of compressions to the veins, thereby facilitating the flow of blood. The continuous flow of blood will reduce or eliminate any areas of stasis so clots do not have a chance to form. For people who are confined to a bed or will be immobile for an extended period of time, leg elevation is recommended. This will promote blood return to the heart and will decrease any existing venous congestion.

Graduated compression stockings have also been used to apply pressure to the veins so as to reduce or minimize any areas of low flow in the vein, while not allowing the collection and coagulation of blood in these low flow areas. The stockings are designed to provide the highest level of compression to the ankle and calf area, with gradually decreasing pressure continuing up the leg. The stockings prevent DVT by augmenting the velocity of venous return from the legs, thereby reducing venous stasis. Typically, stockings are applied before surgery and are worn until the patient is fully able to move on their own. The stockings need to fit properly and be applied correctly. If too tight, they may exert a tourniquet effect, thereby promoting venous stasis, the very problem they it to prevent. If too loose, the stockings will not provide adequate compression.

Another treatment of DVT involves the use of intermittent pneumatic compression (IPC). IPC can be of benefit to patients deemed to be at risk of deep vein thrombosis during extended periods of inactivity and is an accepted treatment method for preventing blood clots or complications of venous stasis in persons after physical trauma, orthopedic surgery, neurosurgery, or in disabled persons who are unable to walk or mobilize effectively.

An IPC uses an air pump to inflate and deflate airtight sleeves wrapped around the leg. The successive inflation and deflations simulate the series of compressions applied to the veins from muscle contractions, thereby limiting any stasis that can lead to thrombi formation. This technique is also used to stop blood clots from developing during surgeries that will last for an extended period of time.

While there are a number of airtight sleeves that have been developed for IPC, the available sleeves are created from multi-layered materials and are relatively expensive to manufacture. For instance, in currently available airtight sleeves, an air bladder is provided and encased in a multi-layered garment that requires a great deal of manufacturing effort, including the careful cutting and stitching of multiple layers of cloth suitable for prolonged placement against a patient's skin. Indeed, the airtight sleeves currently available are formed with a soft inner layer material that is suitable for contact with the skin, and an outer layer that is more durable and serves as a backing to provide the necessary compression to the patient. This two-layer construction results in an expensive and complicated manufacturing of the airtight sleeve. Also, the combination of two (2) dissimilar materials requires a perimetric piping that serves to finish the cut edges of the two (2) dissimilar materials, to connect the two (2) materials together, and to provide a finished edge.

In light of the above, it would be advantageous to provide a deep vein thrombosis prevention garment that minimizes the occurrence of deep vein thrombosis formation. It would be further advantageous to provide a deep vein thrombosis prevention garment that allows medical personnel to customize the compression of limbs being treated to optimize treatments for particular patients. It would be further advantageous to provide a deep vein thrombosis prevention garment that is made from a single panel of material and a one-step welding process, thereby minimizing manufacturing steps and costs and eliminating the need for tricot lining and binding. It would also be advantageous to provide a deep vein thrombosis prevention garment that is easy to use, relatively easy to manufacture, and comparatively cost efficient.

### SUMMARY OF THE INVENTION

The non-woven garment for deep vein thrombosis prevention of the present invention (hereafter referred to as the “deep vein thrombosis prevention garment”) includes a body having a central panel, a left side panel, and a right side panel formed with a number of attachment straps having an integral fastener, such as Velcro® brand hook and loop fasteners. The central panel is to form a single air chamber which receives air from a pump through a flexible air supply tube, when it is welded with a cover, forming a trapezoidal weld.

The central panel, left side panel and right side panel are formed from a single material which requires no skin-safe liner or other combination of materials. A cover sized to cover the inside surface of the body of the deep vein thrombosis prevention garment of the present invention is welded along its perimeter to the body of the deep vein thrombosis prevention garment of the present invention. The cover and the body are made from the same material which can be placed against a patients skin.

The deep vein thrombosis prevention garment of the present invention adopts a Raid Frequency (RF) welding technique, which discloses a one-step RF welding process that eliminates the need for tricot lining and binding for the garment.

In use, the central panel is positioned against the large muscle in the limb being treated, such as the calf muscle, and the left side panel is wrapped around the limb. The attachment straps of the right side panel are wrapped around the limb from the other direction and attached to the outside surface of the cover to secure the device about the patients limb.

The deep vein thrombosis prevention garment of the present invention is worn by a patient on an extremity that is subject to development of thrombosis, particularly deep vein thrombosis, and particularly during surgery or extended periods of inactivity. In use, the deep vein thrombosis prevention garment is wrapped snugly around a patients leg, for example. Once activated, the pump provides a periodic air supply to the garment through the flexible air supply tube leading to the air chamber.

The air pressure is maintained through the flexible air supply tube, the air filled chamber becomes pressurized to a predetermined pressure, such as 35 mmHg. As the air filled chamber inflates, it provides additional pressure on the leg of the patient to urge blood flow further upward through the leg.

The inflation of the air-filled chamber, coupled with the valves within the venous structure of the limb, creates a peristaltic force on the veins within the limb being treated. Once the air filled chamber is pressurized to a predetermined pressure, the pressurized aft supplied to the flexible air supply tube is discontinued, and the aft filled chamber deflates, returning the deep vein thrombosis prevention garment of the present invention to its fully un-inflated configuration. In this fully un-inflated configuration, blood flows freely through the limb being treated.

The inflation and deflation timing cycle of the deep vein thrombosis prevention garment of the present invention is determined by the pressures being utilized, and the speed by which the air chambers deflate. In order to effectively urge blood flow through deep veins, the timing for the peristaltic effect of the deep vein thrombosis prevention garment of the present invention is approximately twenty (20) seconds per cycle.

### BRIEF DESCRIPTION OF THE DRAWING

The nature, objects, and advantages of the present invention will become more apparent to those skilled in the art after considering the following detailed description in connection with the accompanying drawings, in which like reference numerals designate like parts throughout, and wherein:

FIG. 1 is a top plan view of the deep vein thrombosis prevention garment of the present invention showing a central panel, a left side panel, and a right side panel of the body formed with a number of attachment straps having an integral fastener, and with the central panel where an air filled chamber is formed to receive air from a pump through a flexible air supply tube when the body and the cover of the deep vein thrombosis prevention garment are welded through RF welding method along the perimeter of the garment and the trapezoidal perimeter of the central panel;

FIG. 2 is a view of the deep vein thrombosis prevention garment being used by a patient for the prevention of deep vein thrombosis, showing a pump supplying pressurized air through a flexible air supply tube;

FIG. 3 is a side cross-sectional view of the deep vein thrombosis prevention garment of the present invention as taken along line 3-3 of FIG. 1, showing the relative positions of the air filled chamber when the deep vein thrombosis prevention garment is in a partially inflated configuration, and demonstrating the flow of air within the air filled chamber;

FIGS. 4-5 depict the deep vein thrombosis prevention garment of the present invention as used on the leg of a patient starting with an un-inflated configuration, and advancing through the inflation of the air filled chamber;

FIG. 4 is an exemplary partial cross-sectional view of the deep vein thrombosis prevention garment of the present invention as used on the leg of a patient, showing the deep vein thrombosis prevention garment in a deflated configuration in which little or no pressure is exerted on the leg of the patient and blood flows unrestrictedly through the leg;

FIG. 5 is an exemplary partial cross-sectional view of the deep vein thrombosis prevention garment of the present invention as used on the leg of a patient, showing the deep vein thrombosis prevention garment in a partially inflated configuration with the air filled chamber filled with air to provide pressure on the leg of the patient to urge blood flow upward through the leg: and

FIG. 6 is a graphical representation of the air pressure supplied from the pump to the deep vein thrombosis prevention garment of the present invention, showing a maximum air pressure to be delivered, and the sequential pressure within the air filled chamber during an inflation cycle before pressure supplied from the pump is released and all air filled chambers deflate.

### DETAILED DESCRIPTION OF A PREFERRED EMBODIMENT

Referring initially to FIG. 1, a top plan view of the deep vein thrombosis prevention garment of the present invention is shown and generally designated 100. The deep vein thrombosis prevention garment 100 includes a body 102 having a central panel 104, a left side panel 106, and a right side panel 108. In a preferred embodiment, the outer layers of body 102 and cover 112 of the deep vein thrombosis prevention garment are made from durable cloth or other non-woven and air non-permeable material that can comfortably contact a patient's skin. For instance, a non-woven material SONTARA made from polyester and a substantially recyclable wood pulp may be suitable for use as the outer layers of body 102 and cover 112 of the deep vein thrombosis prevention garment of the present invention.

The air filled chamber 111 is formed when body 102 and cover 112 (with a portion cut away for clarity), both made of the same material, are welded together with an aid of one-step RF welding technique. The present invention adopts the RF welding technique which welds the entire body 102 and cover 112 of the deep vein thrombosis prevention garment, including attachment straps 120, 122, and 124, all in one (1) step. RF welding is the process by which electromagnetic energy is used to permanently bond thermoplastic materials together and dielectric materials are mostly used in RF welding. Dielectric materials are electrical insulators or in which an electric field can be sustained with a minimal dissipation of power.

By adopting such dielectric materials for the inner layers of body 102 and cover 112, the present invention eliminates the need for tricot lining and binding. The present invention also does not need a separate bladder to form an air filled chamber. Instead, the RF welding method adopted in the present invention allows an air filed chamber to be formed from welding of the two (2) layers of body 102 and cover 112 made of the same materials, and this one-step welding process forming an air filled chamber is completed in a short time. Thus, the present invention significantly reduces the manufacturing steps, time and cost. In addition, less material is used for the present invention and therefore, the present invention discloses a deep vein thrombosis prevention garment which is more earth friendly.

In the present invention, the body 102 and the cover 112 are welded along the perimeter of the deep vein thrombosis prevention garment of the present invention, and the perimeter 114 of trapezoidal air filled chamber formed from welding of the body 102 and the cover 112. Through the RF welding technique used in the present invention, weld 150 along the perimeter of the deep vein thrombosis prevention garment and weld 138 forming an air filled chamber 111 along the perimeter 114, are resulted. In addition, welds 150 and 138 are slightly depressed through the RF welding process. Both body 102 and cover 112 are made of an air non-permeable foam layer for their outer surfaces and a dielectric material for their inner surfaces welded.

As shown in FIG. 1, air supply tube 110 leads to an net 144 which extends into air filled chamber 111 formed from weld 138, along with the trapezoidal perimeter 114, to inflate the air chamber. Inlet 144 is sealed to the inside layer of central panel 104 and cover 112 to prevent leakage. In addition, the flexible air supply tube 110 having a non-descript length is shown and it is to be appreciated that the length of the air supply tube 110 may vary depending on the particular field of use, and the selling. For instance, in a hospital surgery setting, it may be difficult to position an air source immediately adjacent to the patient, and an extended air supply tube 110 is required.

Air is supplied to flexible air supply tube 110 from a pump 140. In a preferred embodiment, pump 140 includes a compressor capable of providing a predetermined maximum air pressure that provides a pressure force to fill the air filled chamber 111. Air supply tube 110 is equipped with a quick-disconnect connector 142 known in the industry to facilitate the changing of multiple deep vein thrombosis prevention garments 100 with pump 140. As will be described in greater detail below, pump 140 can provide air at a predetermined pressure for a predetermined period of time, providing for an inflation and deflation cycle according to the desired therapy parameters.

As shown in FIG. 1, right side panel 108 is formed with a number of attachment straps 120, 122, and 124, with each strap having an integral fastener 126, 128, and 130, respectively. In a preferred embodiment, straps 120, 122, and 124 are provided with the hook portion of hook-and-loop style fasteners 126, 128, and 130. This hook portion of the hook-and-loop fastener cooperates with the outside of cover 112, to allow the deep vein thrombosis prevention garment 100 of the present invention to be positioned about a patient's limb and secured in place by wrapping the panels 104, 106 and 108 around the limb and pressing the fasteners 126, 128, and 130 on straps 120, 122, and 124 firmly against outside of cover 112. The hook-and-loop fasteners are attached to the outside of cover 112 to hold the straps 120, 122, and 124 in place. This type of fastener and method of attachment of the deep vein thrombosis prevention garment 100 provide a deep vein thrombosis prevention garment for patients having limbs of different sizes and can accommodate large or small diameter limbs simply by wrapping the panels 104, 106 and 108 around the limb and securing straps 120, 122, and 124 in place.

In a preferred embodiment, polyester made from recycled bottles may be used for the loop fastener material, such as yarn made from recycled polyester available from UNIFI under the trade name REPREVE. In addition, with an aid of the cover 112 equipped with an air non-permeable surface having a foam layer, in a preferred embodiment of the present invention, the loop fasteners 126, 128, and 130 can be attached to the foam layered surface of the cover 112 without using the loop portions for the fasteners and a limitation for a specific attachment point. Alternatively, the outer surface of right side panel 108 may be equipped with the loop portion of the hook-and-loop fasteners to provide a specific attachment point for fasteners 126, 128, and 130. While the preferred embodiment of the deep vein thrombosis prevention garment of the present invention is manufactured having hook-and-loop type fasteners 126, 128, and 130, it is to be appreciated that any other fastener known in the art may be used without departing from the present invention.

Referring now to FIG. 2, the deep vein thrombosis prevention garment 100 of the present invention is shown being used by a patient 200 for the prevention of deep vein thrombosis. Specifically, as shown, the deep vein thrombosis prevention garment 100 is positioned around the lower leg 202, or calf, of patient 200 and in communication with pump 140 through flexible air supply tube 110. Pump 140 supplies pressurized air through flexible air supply tube 110 to pressurize the air filled chamber 111 within the deep vein thrombosis prevention garment 100 (as shown in FIG. 1).

FIG. 2 depicts a patient in a sifting position. However, this is merely exemplary of the typical use of the deep vein thrombosis prevention garment 100 of the present invention. Indeed, the deep vein thrombosis prevention garment of the present invention may be used with the patient virtually in any position. As will be described in greater detail below, the inflation and deflation cycle of the air filled chamber 111 (shown in FIG. 1) may vary depending on the particular patient, and the particular environment. For instance, a patient using the deep vein thrombosis prevention garment of the present invention in a sitting position may opt for a faster inflation and deflation cycle, and may utilize higher air pressure in the air filled chamber 111 than a patient using the deep vein thrombosis prevention garment in a supine position on an operating table.

It is also to be appreciated that while FIG. 2 depicts a patient 200 having one (1) deep vein thrombosis prevention garment on a leg, a number of deep vein thrombosis prevention garments may be used simultaneously. For instance, in a surgery setting, it is commonplace to utilize the deep vein thrombosis prevention garment of the present invention on both legs.

As shown, the deep vein thrombosis prevention garment 100 is positioned around the calf 202 of patient 200 by positioning panels 104 (shown in FIG. 1) and 106 against the patient's leg, and then wrapping straps 120, 122, and 124 of right side panel 108 (shown in FIG. 1) around the calf 202 and securing the straps to the outside surface of cover 112 with fasteners 126, 128, and 130 (shown in FIG. 1).

Referring now to FIG. 3, a side cross-sectional view of the deep vein thrombosis prevention garment of the present invention as taken along line 3-3 of FIG. 1 is shown. As shown in FIG. 3, the construction of the deep vein thrombosis prevention garment 100 includes air filled chamber 111 which is formed with weld 138 along the trapezoidal perimeter 114 (shown in FIG. 1) when the body 102 and the cover 112 are welded. Cover 112 is welded to central panel 104 of the body 102 along the trapezoidal perimeter 114 and the RF welding technique adopted in the present invention welds the inner layers 134 and 136 of the central panel 104 and cover 112, respectively, forming weld 138. The inner layers 134 and 136 are made of dielectric material and the RF welding process forms weld 138 in a geometric shape of a trapezoid for the air filled chamber 111. The air filled chamber in a trapezoidal shape is specifically adopted since the trapezoidal shape is better to be wrapped around a calf muscle of the patient and further to improve blood movement. Air filled chamber 111 is formed from the inner layer 136 of the cover 112 and the inner layer 134 of the central panel 104 on the body 102, where these two (2) layers define an air cavity 132. The inner layer 134 of the central panel 104 on the body 102 and the inner layer 136 of the cover 112 are made of the same flexible and durable materials and such materials are capable of withstanding prolonged periods of inflation and deflation without damage.

The weld 138 formed by the RF welding method provides for an air-tight seal between the two (2) layers of the inner layers 134 and 136, allowing for the pressurization of the resulting air filled chamber 111. Specifically, the inner layers 134 and 136 are sealed together at weld 138 to establish a flexible, yet air-tight bond between them.

The air supplied from air supply tube 110 and pump 140 (shown in FIGS. 1-2) flows in direction 146 into air filled chamber 111. For clarity, directional arrows 146 depict the typical airflow within the air filled chamber 111. From this Figure, the expandability of the air filled chamber 111 is easily appreciated. As air filled chamber 111 is provided with pressurized air and the pressure in the air filled chamber 111 will continue to rise until the air filled chamber pressure equalizes with the pressure of the air from pump 140.

Referring now to FIGS. 4 and 5, the deep vein thrombosis prevention garment 100 of the present invention is shown as used on the leg 202 of a patient 200 starting with an un-inflated configuration in FIG. 4, and the inflated configuration in FIG. 6.

Starting with FIG. 4, an exemplary cross-sectional view of the deep vein thrombosis prevention garment 100 of the present invention as used on the leg 202 of the patient 200 (shown in FIG. 2), depicting the deep vein thrombosis prevention garment 100 in a deflated configuration, is shown. In the deflated configuration, little or no pressure is exerted on the leg 202 of the patient and blood flows unrestrictedly through the leg. As air is introduced into tube 110 (shown in FIGS. 1 and 2) and begins to fill air cavity 132 of air filled chamber 111 (as depicted in FIG. 3 with air flows 146), pressure is introduced to leg 202.

As shown in FIG. 5, as air is continually introduced into air cavity 132 of air filled chamber 111 (shown in FIGS. 1 and 3), an increase in pressure is applied to leg 202 of the patient 200 to urge blood flow upward from the foot 204 through the leg 202 in direction 206. Specifically, inflation of air filled chamber 111 creates a pressure on the limb 202 of patient 200.

When the inflation cycle is completed, the air pump 140 (shown in FIGS. 1-2) releases the air pressure to air supply tube 110, and air dissipates through the air supply tube 110 in reverse of direction 146 (shown in FIG. 3) to return the deep vein thrombosis prevention garment 100 of the present invention to its deflated state as shown in FIG. 4. Following a delay, this cycle is repeated according to a particular patient profile, and may be repeated for extended periods of time in order to minimize the likelihood that thrombosis will develop in the patient.

This cyclic pressure of an inflation cycle, in combination with the inter-venous valves present in the circulatory system, provides a peristaltic force on blood within the limb. The peristaltic force results in the near continual movement of blood within the limb being treated, thereby avoiding the formation of deep vein thrombosis.

Referring now to FIG. 6, a graphical representation of the air pressure supplied from the pump 140 (shown in FIGS. 1-2) to the deep vein thrombosis prevention garment 100 of the present invention is shown and generally designated 250. Graph 250 includes a vertical Air Pressure axis and a horizontal Time axis. This graph 250 depicts a typical inflation and deflation cycle that occurs in the deep vein thrombosis prevention garment 100 of the present invention.

Graph 260 includes a primary supply air pressure curve 252 which corresponds to the aft provided by pump 140 to flexible aft supply tube 110. This air supply begins at the start of the inflation cycle and rises to a maximum supplied air pressure 254. This maximum supplied air pressure 254 is approximately equal to an overall maximum pressure 256 (shown by dashed line) that corresponds to the maximum desired pressure within air filled chamber 111 (shown in FIGS. 1 and 3-5), the maximum pressure medically safe, or any other maximum value utilized in the art to ensure safe operation of the deep vein thrombosis prevention garment 100.

In the deep vein thrombosis prevention garment 100 of the present invention, the preferred maximum pressure for air filled chamber 111 is 35 mmHg. It is to be appreciated, however, that different air pressures may be utilized for differing applications, treatment positions, duration of treatment, and other factors known and considered in the art.

The inflation cycle is completed once the air filled chamber 111 has had sufficient time to inflate. Following the inflation cycle, a delay 258 may be utilized to maintain a constant pressure on the limb 202 (shown in FIGS. 2 and 4-5) to provide time for the blood to flow through the limb. Following any delay, the deflation cycle begins and the pressure 260 in air supply tube 110 decreases to zero.

As the decrease in air supply tube pressure 260 occurs, the pressure 262 in air filled chamber 111 likewise returns to zero in substantially the same time. Once this inflation and deflation cycle is complete, a delay 264 may be Inserted prior to beginning the next inflation and deflation cycle.

Using the deep vein thrombosis prevention garment 100 of the present invention, the time for a complete inflation cycle, deflation cycle and delay is approximately twenty (20) seconds. As a result, the deep vein thrombosis prevention garment 100 can be cycled three (3) times every minute in order to provide a continuous force to create the desired peristaltic effect. It is to be appreciated that the specific period for a complete cycle may be changed depending on the size of the limb being treated, the pressure desired, and the peristaltic forces necessary to minimize the likelihood of the development of a thrombosis.

While there have been shown what are presently considered to be preferred embodiments of the present invention, it will be apparent to those skilled in the art that various changes and modifications can be made herein without departing from the scope and spirit of the invention.

1. A deep vein thrombosis prevention garment, comprising:
a cover;
a body having a central panel;
a left side panel extending from said central panel; and
a right side panel extending from said central panel opposite said left side panel and formed with one or more attachment straps having an integral fastener attachable to said left side panel;
wherein the cover and body are welded together along the perimeter of the garment, and
wherein the cover and body are welded together along the perimeter of the central panel to form an air chamber panel configured to receive air from an air supply tube.

2. The deep vein thrombosis prevention garment of claim 1, wherein the cover and body are welded using radio frequency energy.

3. The deep vein thrombosis prevention garment of claim 1, wherein the cover and body are constructed from an air non-permeable foam layer for their outer layer and a dielectric material for their inner layer.

4. The deep vein thrombosis prevention garment of claim 1, wherein the shape of the air chamber is trapezoidal.

5. The deep vein thrombosis prevention garment of claim 1, wherein the air supply tube is sealed to the inside layer of the central panel and the cover.

6. The deep vein thrombosis prevention garment of claim 1, wherein the integral fasteners are hook and loop style fasteners.

7. The deep vein thrombosis prevention garment of claim 6, wherein the hook portion of the hook and loop style fastener cooperates with the outer layer of the cover to secure the garment in placed when wrapped around a patient's limb.
